(19) United States
(12) Patent Application Publication
(10) Pub. No.: US 2025/0303837 A1
(43) Pub. Date: Oct. 2, 2025

(54) PROTECTIVE FLOOD DEVICE

(71) Applicant: Armando Dominguez, Pembroke Pines, FL (US)

(72) Inventor: Armando Dominguez, Pembroke Pines, FL (US)

(21) Appl. No.: 19/086,392

(22) Filed: Mar. 21, 2025

Related U.S. Application Data
(60) Provisional application No. 63/731,089, filed on Apr. 1, 2024.

(51) Int. Cl. B60J 11/00

(52) U.S. Cl. CPC B60J 11/00

(57) ABSTRACT

A flood-protective device has been invented to protect valuable articles from flood water, including cars, using an airtight material aided by a mesh that covers the article's external surfaces, leaving the bottom section open and creating an internal air bubble. When installed on a car, it creates an air bubble in the cabin, hood, and trunk sections when the flood progresses.

It can protect cars from heavy floods using the mesh sheet that thoroughly covers the plastic sheet and is tensed with a surround rope or something similar. It creates an open perimetral bottom section between the tire's contact stationary surfaces, secured to at least one anchor fixed to the stationary surface. It can add protection by installing an automatic compressed air dispenser to feed air inside the bubble section and push away the flood water to keep a substantial separation from articles sensible to contact with water.

### CROSS-REFERENCE TO RELATED APPLICATIONS

This application claims the benefit of a provisional patent application Ser. No. 63/731,089 filing on Apr. 1, 2024.

### FEDERAL-SPONSORED RESEARCH

none

### FIELD OF THE INVENTION

This invention fits in devices for protection from flooding.

### BACKGROUND—PRIOR ART

Due to the changes in the global climate, so many unexpected flood events are occurring. These events are predictable, so the evacuation of people can save lives, but valuables, including vehicles, must be left at the mercy of the flood. Although some methods to protect cars against flooding require much time to install and some training. To preserve other objects, they must be stored in airtight containers or large bags, which are expensive.

Currently, many covers to protect vehicles from flooding are available, but no one has successfully protected them from a flood at a medium or large level.

Existing protective car covers that protect from elevated levels must be installed by three people, and the vehicle must be entered into a sealed bag for wrapping; then, the car must be secured to a structure such as a column. The vehicle's trunk must have heavy articles to compensate for the weight of the front car components. This process takes time, and the vehicle might appear elsewhere when the flood ends.

No existing flood protective covers can be installed for one person.

### SUMMARY

The present invention comprises an airtight or rain-protective cover attached to an article's external surface placed on a stationary surface to protect it when that threatens to be damaged by water flooding.

The cover can be gathered from simple plastic sheets surrounding the object without needing to be wrapped in the bottom; the invention performs like the ant nest.

The internal section of the cover creates an air bubble in the presence of a flood.

The flood protective assembly can be constructed utilizing a flexible, airtight material or plastic sheet fully covered with a mesh sheet, or it can be a single piece of vinyl having the inverted shape of the object, secured by ropes, belts, or wires to at least one anchor fixed to the stationary surface to avoid the wrapped object floats.

The mesh sheet surrounds the bottom section of the protected object and is pulled against all the object surfaces, leaving minimal space between the external surface and the airtight sheet; this can be achieved by passing a rope through the mesh sheet openings located in the closest to the stationary surface and tense and coupled to the anchor set. The mesh sheet adds mechanical resistance to the airtight sheet to maintain the bubble at a substantial protection volume and minimize the volume losses.

An additional embodiment includes an air reservoir connected to an automatic air feeder with a water detection sensor and a deflator valve to yield compressed air into the bubble and increase its volume until it displaces the water to reach a desired level. In the cases of mobile vehicles, compressed air storage in the tires can be utilized as the reservoir; this can be a single automatic air feeder connected to all tires, separate automatic air feeder controllers connected to each tire, or a combination of air reservoir and tires.

The invention comprises a mesh sheet that wraps an airtight plastic sheet that can be an existing rain car protective cover that is on sale in the market or a type of construction plastic sheet or vinyl surrounding the article that is intended to be protected; however, the plastic sheet must be the most possible close to the object surface.

These embodiments of the invention also protect utilitarian distribution boxes, transformers, structures, and any bulky object, including plants.

It is dependable and can be used during severe flooding as a secure container for storing valuable items, personal keepsakes, and essential documents.

The disclosure invention helps to protect the environment, avoiding contaminator vehicle fluids going to the subsoil water and ground.

### SPECIFICATION

### Drawing Figures

FIG. 1 shows a prior art figure.

FIG. 2 shows a perspective view of the present invention.

FIG. 3 illustrates a bottom view.

FIG. 3A illustrates a cut section view from FIG. 3.

FIG. 4 illustrates a cut section view.

FIG. 5 shows a perspective view.

FIG. 6 illustrates an elevation view.

FIG. 7 shows a perspective view.

FIG. 8 illustrates a perspective view.

FIG. 8A shows a cut section view coming from FIG. 8.

FIG. 9 illustrates a schematic view.

FIG. 9A illustrates a schematic view.

FIG. 10 shows an elevation view.

FIG. 11 illustrates an elevation view with an additional embodiment.

FIG. 12 shows an elevation view of another additional embodiment.

FIG. 13 illustrates an elevation view.

### DRAWINGS—REFERENCE NUMERALS

100—preferred embodiment
115—plastic sheet
120—bottom section
125—surface shape
130—bottom opening perimeter
130a—bottom right edge
139b—bottom front edge
130c—bottom left edge
130d—bottom rear edge
140—airtight material
142—perimeter rope
143—spiral rope
144—cover for the front car section
145—cover for the trunk car section
146—front body rope
147—trunk body rope
149—rings
150—prior art vehicle
151—link
155—prior art waterproof bag
156—battery
157—engine
160—air bubble
165—arrow force direction
200—object to be protected
205—external surfaces
230—car front surface
231—car trunk surface
244—front car section
245—trunk car section
300—stationary surface
310—anchor
311—anchor rope cavity
400—flooding
405—flooding level
410—flooding bubble level
500—automatic pressurized air dispenser
501—automatic pressurized air from all the tires
502—automatic pressurized air from independent tires
510—air container
511—air pressure gauge
512—compressed air
513—electromechanical valve
514—compressed air existing
515—water presence sensor
516—outlet port
517—relief pressure valve
518—water level controller
520—power supply
521—car battery
525—air filler port
530—air deflator
540—power supply male plug
542—air hose
545—electro valve inlet
546—electro valve outlet
550—inflator port
552—arrow displacement direction
560—arrow displacement direction

### DETAILED DESCRIPTION

The flood protective device appears in figures with heavy lines surrounding the article contour.

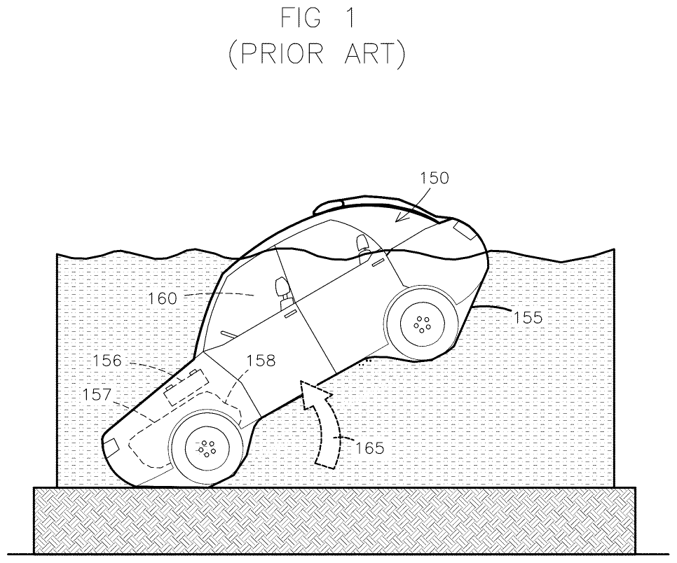

FIG. 1 illustrates a prior art figure where it can be noticed that vehicle 150 is introduced into a prior art watertight bag 155 but is inclined during the flooding due to the distribution of the weighing components, such as battery 156, engine 157, and transmission 158, which are attached to the front section of the vehicle 150, allowing the air bubble 160 to exert an opposing gravity force more significant than the combined weight of the center and rear side of the car, then pushing it in direction of the arrow 165.

The further disclosure description teaches how to protect many valuable goods from heavy floods, including vehicles.

A preferred embodiment will be illustrated partly as a flood protective cover for protecting the car, but the invention is not limited to specific objects depicted in the specification.

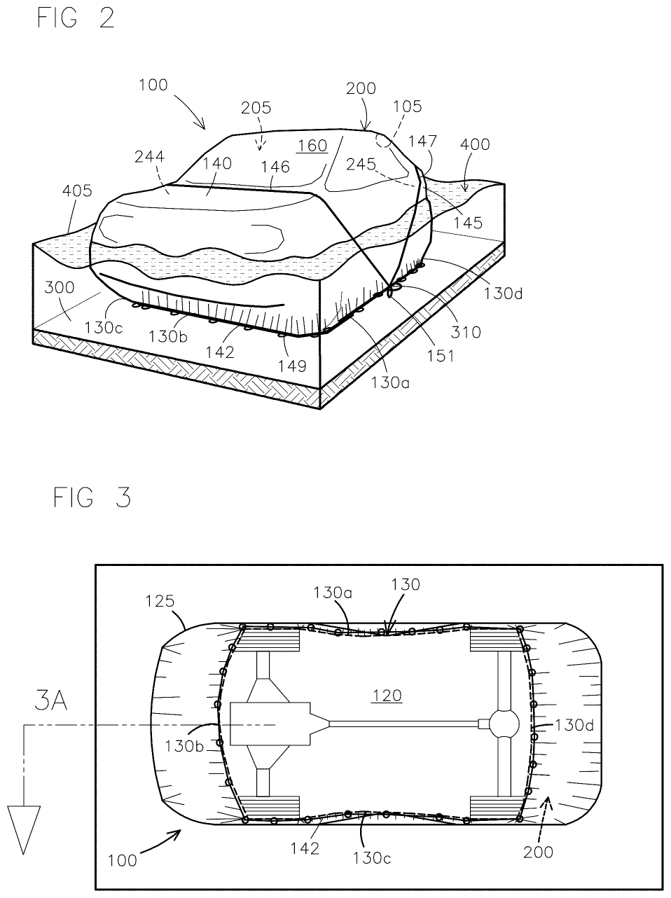

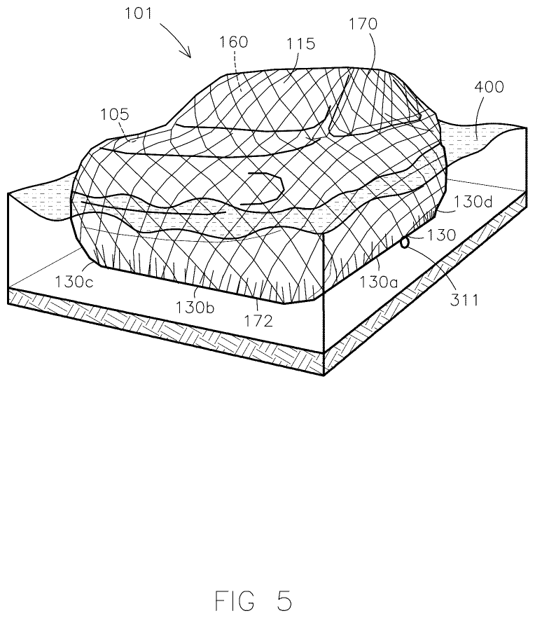

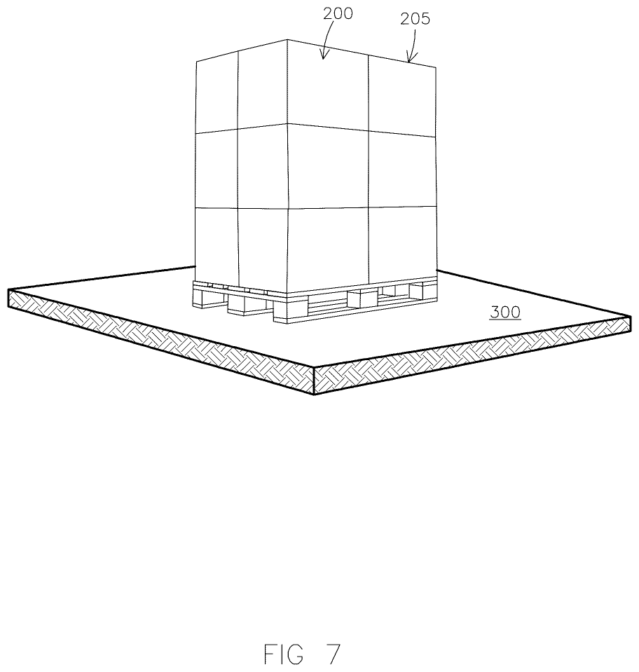

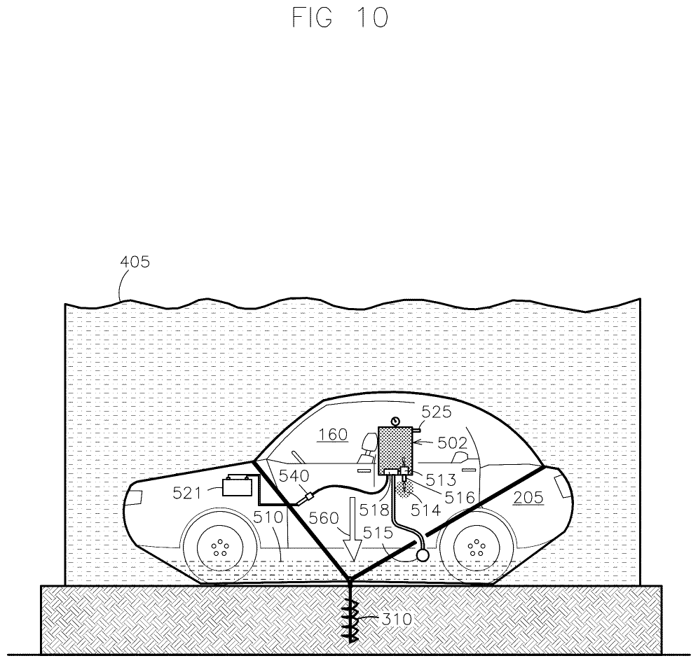

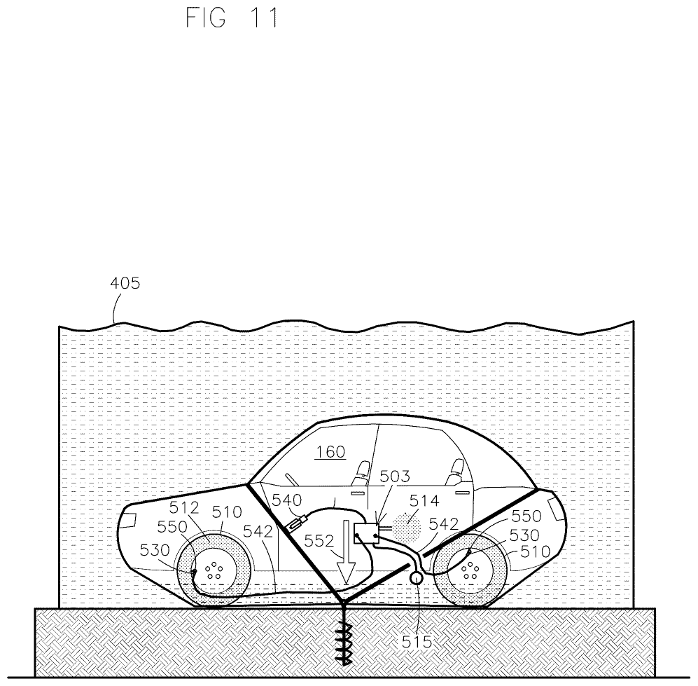

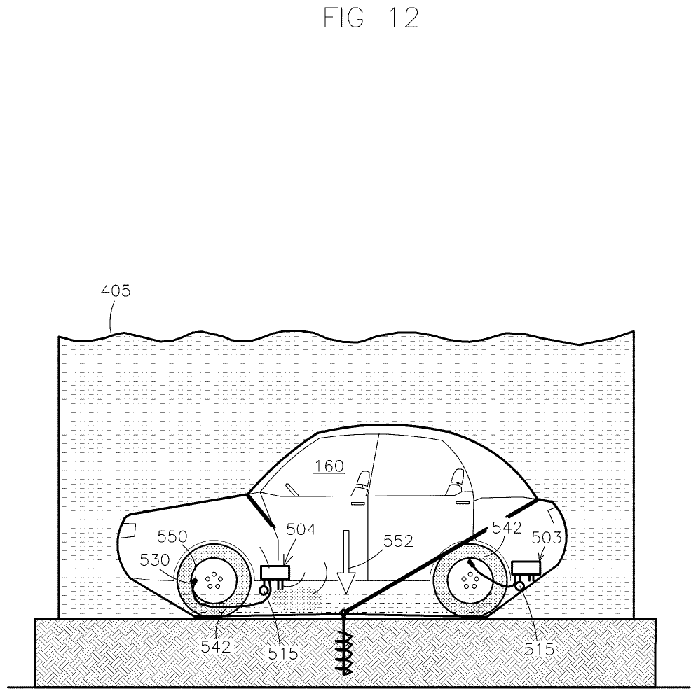

FIG. 2-13. Comprise effective, reliable, economical, and quick installation flood protective assembly to protect from flooding an object 200 placed on a stationary surface 300, with open bottom-section 120, having an inverter car surface shape 125 made of a watertight material 140 gathered by different means, including molding, belts and mesh sheet combined with plastic sheets or likes.

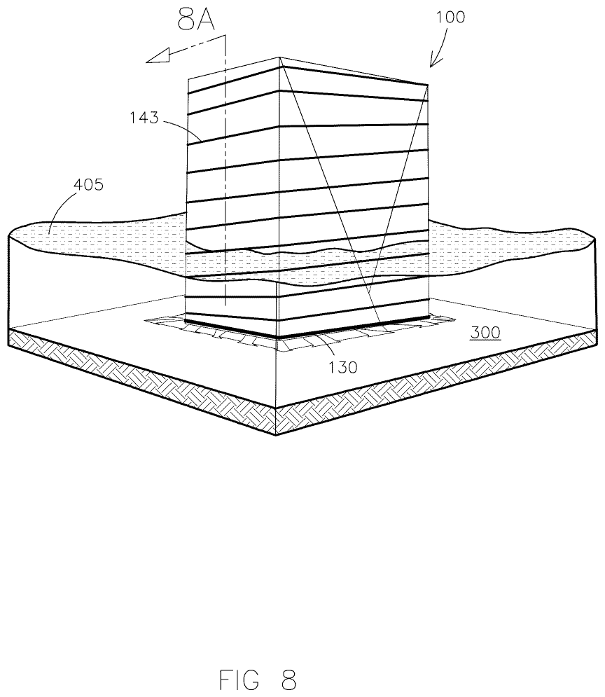

The preferred embodiment 100 is made of an airtight material 140, which fully covers object 200, intended to be protected from a flood 400. Still, it can also be a flat sheet that wraps completely the top and all sides of an object 200, see FIGS. 7, 8, 8A, and 13, something like wrapping a box with a wrapping plastic sheet, leaving open the bottom section. The airtight material 140 should be in contact with all of the car's external surfaces 205 of object 200. Covering the bottom section 120 is unnecessary.

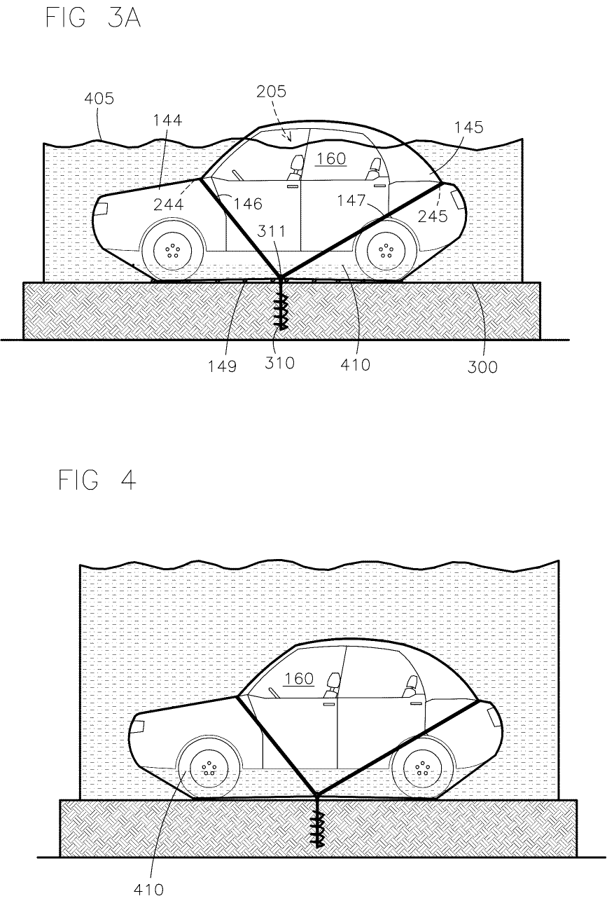

FIG. 3: The open bottom section 120 will be created by a perimeter rope 142 or like, which joins and firmly holds around the bottom edges 130a-130d near or over the stationary surface 300 as illustrated in FIGS. 3, 3A, 4, 5, 6, 8, 8A,10 11,12 and 13, forming a cavity 120 that is maintained by the tensed perimeter rope 142. Rope 142 passes through a set of 149 perimeter rings disposed around cavity 120, and a front rope 146 wraps the front car cover 144, a trunk rope 147 wraps the cover trunk car 145, both ropes couple to the rope 142.

FIGS. 2, 3, and 3A. The cover front car section 144 and the cover trunk car section 145 are pulled against the car front and car trunk surfaces 244 and 245, respectively, by front rope 146. The trunk rope 147, which is coupled to the set of bottom section ropes edges 130a-130d, that pass-through cavities or rings 149 for housing the rope 142, which is fixed to at least one anchor 310 permanently attached to the stationary surface 300 designed to hold the entire car 200 during a flooding event. This assembly creates a space or bubble 160 with a mechanical function like an ant nest. We must remember that anthills withstand flooding because the ants have built a concave section or impermeable hull that becomes an air bubble while the water covers it.

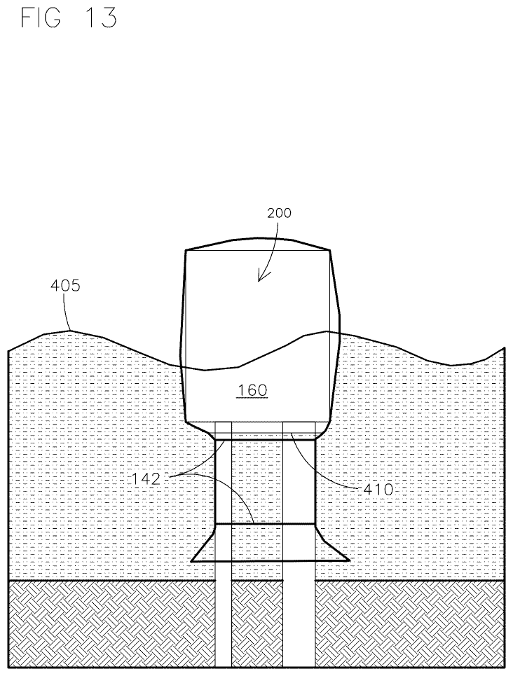

FIG. 13. The interior side of the car, including the cabin, forms the bubble section 160. The above disclosure embodiment can protect utilitarian services distribution boxes 200, vehicles, freight, structures, plants, and any object with a bulky shape.

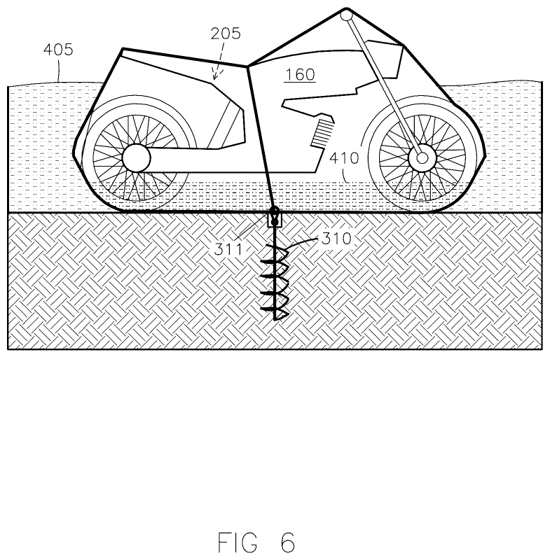

FIGS. 5 and 3. A first additional embodiment 101 includes a plastic sheet 115 covering all of the object 200, which is intended to protect from flooding 400, a mesh sheet 170 fully wraps the plastic sheet 115, the bottom mesh sheet apertures 172 allow to pass through the perimeter rope 142 or like to close the most possible the bottom open perimeter 130 to avoid an interior flooding level 410 reach sensible to water interior components.

The mesh 170 compressed plastic sheet 115 against all the object's external surfaces 205, providing an extra means of sealing, delaying occasional scrapes of air from the bubble 160.

To prevent the wrapped object 200 from floating on the water, 400 can utilize at least one anchor 310 fixed on the stationary surface 300 and coupled to the mesh sheet 170.

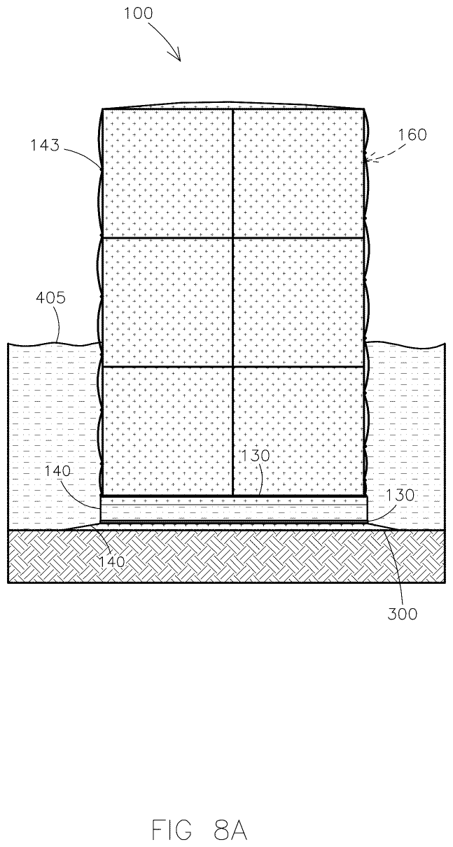

FIGS. 8 and 13. A cubic or cylindrical object 200 can be protected from flooding 400 utilizing a plastic sheet 140 to wrap all external surfaces 205, and a spiral-form rope 143 wrapping the sheet of plastic 140 maintaining a minimal distance between rope loops. The bottom section can be left open.

An economical anchor source exists in the market shed anchor, which appears as a projected boat propeller that can be attached to the ground.

It should be taken into consideration that while the flood level 405 increases, the air pressure inside the bobble 160 increases proportionally, reducing the bobble volume;

then, the difference between the bottom edges of the object and the cover must be calculated according to the expected level of flooding 405 to avoid the bubble flood level 410 reaches the sensible to water parts located in the bottom side of the wrapped object 200.

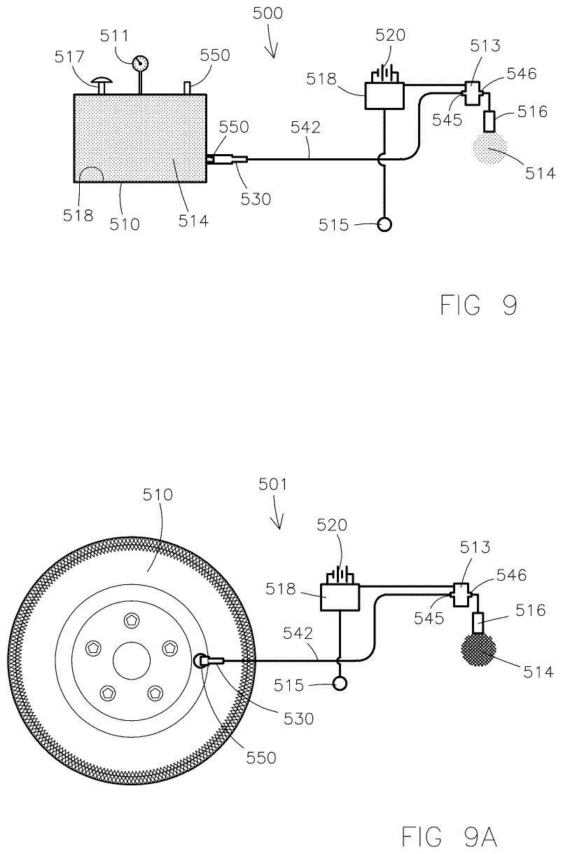

FIGS. 9, 9A, 10, and 11. A second additional embodiment includes an automatic air-compressed container 500 having compressed air 514 in its interior 518, a water presence sensor 515, a means of power source 520, a pressure indicator 511, a refill port 550, an air release valve 517, an air deflator 530, a hose 542 joining the deflator and the electro valve inlet port 545, an outlet inflator port 550, an water level controller 518, an compressed air exit port 516, and electromechanical valve 546.

The automatic air feeder device 500 feeds its storage air 514 inside bubble 160 when the water presence sensor 515 is in contact with the flooding water 510. The above disclosure embodiment pushes away the excess water inside bubble 160 to keep the parts on the bottom side separated from the water flooding 410.

The second additional embodiment also prevents water penetration from damage such as minor cuts in the protective cover or porous materials utilized in the protective cover sheet. It can work with battery packages, an external auxiliary power source, or the car battery.

A third additional embodiment, 501, does the same function as the first 500. Still, it does not have an air container that is replaced for the vehicle tires 510, includes a water level controller 518, a water sensor 515, a battery 520, an electromechanical valve 513, an outlet port 516 connected to an air exit dispenser 516, an inlet port 545 joining a hose 542 and deflator 539 designed to be connected to a tire inlet port 550 which is usually utilized to inflate the vehicle tire 510. This embodiment can work with an external supply or vehicle battery 521.

A fourth additional embodiment, 502, does the same as the present invention's first and second additional embodiments. It is designed to draw compressed air from the tires one by one. It has separated the water level controller 518, power supplies 520, hoses 542, electromechanical valves 513, ports, and air deflectors.

The new flood-preventing cover protects the object from flooding damage. It is reusable, quick to install, economical, and more; anyone can do it without special tools or training.

### Advantages

From the description above, various advantages of the present invention are apparent:

A Protective flood device that utilizes existing sources available in the market for its construction and performance.

An economic device.

An easy-to-understand method of installation.

A fast installation.

A reusable device.

A reliable device.

Waterproof storage in flooding events.

An automatic compressed air feeder pushes away, entering water into the bubble section.

An environment friendly.

1. I claim a flood-protective device created of an airtight material having an inverter internal surface similar to the object's external surface that protects from flood water without wrapping the bottom, creating an internal air bubble when a flooding event happens and threatening to damage an object placed on a stationary surface, preventing the water from entering as does the ant nest, having an open tensed bottom perimetral section surrounding the bottom section closed to the stationary surface.

2. The flood-protective device, as described in claim 1 wherein said perimetral section is attached to at least one anchor fixed to said stationary surface.

3. The flood-protective device, as described in claim 1 wherein said internal air bubble keeps its volume assisted by an automatic compressed air feeder installed in a compressed air reservoir.

4. The flood-protective device, as described in claim 3 wherein said compressed air reservoir is a tank.

5. The flood-protective device, as described in claim 3 wherein said compressed air reservoir is the tires.

6. The flood-protective device, as described in claim 1 wherein said airtight material wrapped by a tense mesh.

7. The flood-protective device, as described in claim 6 wherein said airtight material wrapped by a rope in a spiral shape.
